(19) United States
(12) Patent Application Publication
(10) Pub. No.: US 2009/0229840 A1
(43) Pub. Date: Sep. 17, 2009

(54) Fire-breaking device

(76) Inventor: Jose Luis Jimenez De Castro Fernandez, Toledo (ES)

Correspondence Address: QUINN EMANUEL;KODA & ANDROLIA, 865 S. FIGUEROA STREET, 10TH FLOOR, LOS ANGELES, CA, 90017, US

(21) Appl. No.: 11/920,594

(22) PCT Filed: Mar. 1, 2006
(86) PCT No.: PCT/ES2006/000097

§ 371 Date: Nov. 16, 2007

(30) Foreign Application Priority Data
May 16, 2005 (ES) P 200501188

(51) Int. Cl. A62C 2/16; A62C 3/02

(52) U.S. Cl. 169/48; 169/91

(57) ABSTRACT

The invention relates to a fire-protection device in the form of an easily-transportable barrier which inhibits fire spread in mountains, wooded areas and similar without having to resort to the felling or controlled burning of trees in order to establish said barrier on a soil devoid of fuel. The inventive device comprises a plurality of coaxially-interconnected modules which adopt a long, cylindrical configuration, the structure of which consists of two parts, namely: a lower fixed part (3) and an upper movable part (5) which are interconnected using telescopic cylinders (6) that enable the movable part (5) to be raised to the height required for the fire-protection barrier. In addition, a plurality of nets (7) and louvers (8), which form the actual fire-protection barrier, are provided between the aforementioned elements. Moreover, a plurality of plates are coupled to each net, such as to form longitudinal and vertical lines, and are articulated with the net (7) along the upper edge thereof.

### OBJECT OF THE INVENTION

The present invention refers to a fire-breaking device, i.e. a device used as a barrier against fire spread in woodland, grove and the like.

The object of the invention is to obtain an easily transportable barrier that is size-wise suitable to prevent fire spread without the need for tree felling or controlled tree burning to set it up on a ground with no fuelling elements.

### BACKGROUND OF THE INVENTION

From the preventive point of view and in order to avoid the spread of fire for any cause or reason, “firebreaks” have always been used that consist of wide strips of land, conveniently laid out on the woodland, with no vegetation so that when fire reaches them, it dies out since it cannot move forward due to the lack of fuel. This solution, which is perfectly valid from the theoretical point of view, becomes a problem in practice mainly due to two reasons; on the one hand, for economic reasons or other, firebreaks are not cleaned as frequently as deemed desirable to keep them in optimal working conditions, in other words, with no vegetation or residual firewood; and on the other hand, those firebreaks impair ecosystem development, which is clearly undesirable.

Wherever a firebreak is ineffective, or where it has not been built, it is usually made when the fire breaks out far enough from its frontline, by felling trees and bushes in a controlled manner and eliminating them, or by burning them in a controlled way, which many times is not possible to put into practice due to shortage of time and which in any case implies burning a significant surface that would be unnecessary if the barrier could be made on the very fire frontline, because it is built notably far away from the fire frontline to have enough time to build it.

### DESCRIPTION OF THE INVENTION

The fire-breaking device of this invention fully satisfactorily solves the problem mentioned above since it allows for setting up a barrier that prevents the spread of fire quickly and efficiently and as close to the frontline as possible and with optimal efficiency.

In order to achieve this and in more concrete terms, this fire-breaking device is made up of multiple modules in a longitudinal alignment on the ground—which favours adaptation to its irregularities—with means to couple to one another for suitable continuity; each of these modules has a fixed part to be held down to the ground that has the abovementioned means for mutual coupling or mounting, and an upper mobile part, linked to the fixed part by means of two or more telescopic cylinders that conveniently help lift the mobile part over the fixed one, in furtherance of the height provided for the fire-breaking barrier.

On any one of these elements a roll of mesh that is as wide as the module is set up; also one of the extremes of a blind is fixed as well, the other extreme of which, as well as the mesh's, is fixed to the other part, so that when both parts get apart from each other, these elements, mesh and blind, are rolled out; both are obviously made of materials which, like the rest of the device, are capable of enduring high temperatures that are typical of a forest fire. Many small rectangular plates hang from this mesh; they are fixed to the mesh on the upper edge and make up vertical and horizontal alignments, making up a mesh-like lay-out.

The invention will include another feature: it will have also two side sheets, also rolled inside it, which can roll out to either side of the fixed part, thus covering wide strips of ground (of, for example, 4 metres), so that these sheets, apart from stabilising the barrier against side swinging, cover the ground preventing new fire break-outs near the barrier.

The roll-out meshes will have grids smaller than 1 cm, and the blind sheets will have two different inclinations so that they can close or not in the presence of wind depending on whether its direction helps or not to spread the flames.

It will be preferable for each module to have three meshes and three blinds, used selectively as appropriate.

The fixed part of the piece can be used as a container for water storage, pumped out if necessary over the vegetation; it also includes ancillary elements, such as engines for the telescopic cylinders, batteries for supplying these engines, water pumps, etc.

### DESCRIPTION OF THE DRAWINGS

As a complement to the description presented here, and with the purpose of helping better understand the features of the invention, according to a preferred embodiment, a set of drawings is submitted as an integral part of this description, which illustrating though not limiting, has represented the following:

FIG. 1.—Schematic plan view of a fire-breaking device developed in compliance with the object of the present invention.

FIG. 2.—Cross-section view of one of the modules of the device of the previous figure.

FIG. 3.—Cross-section view similar to the one in FIG. 2, but in which the module appears rolled-out, i.e. making up the barrier for which it was developed.

FIG. 4.—Expanded view of the previous figure at the mobile part.

FIG. 5.—Sample embodiment of one of the blinds making up the device.

FIG. 6.—Front at-elevation view of the device at work, also shown in FIG. 3.

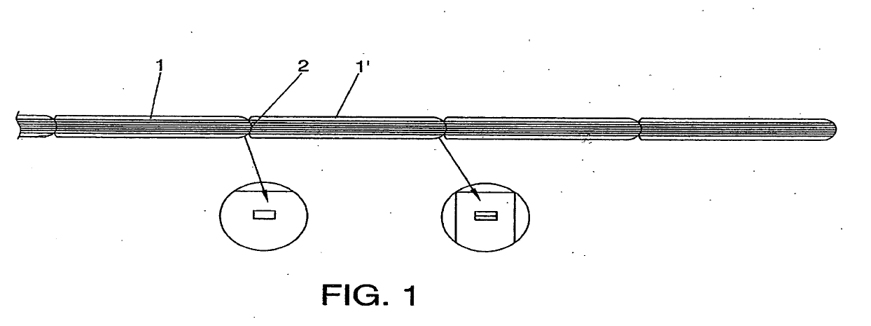

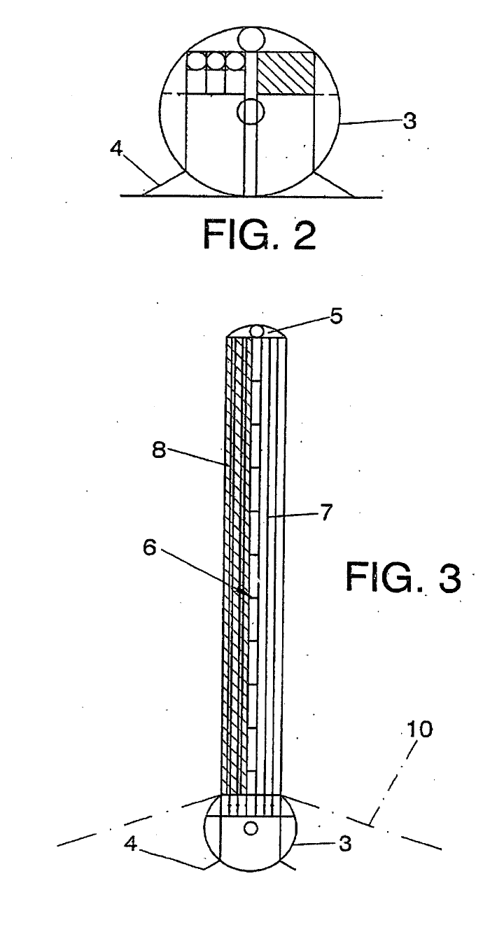

### PREFERRED EMBODIMENT OF THE INVENTION

As shown in the figures described, it can be noticed that the firebreak the invention proposes is made up of a number of modules (1), (1′), . . . , each of which materialises in an empty cylinder with one of the extremes curved-concave and the other one curved-convex for knee-cap-like coupling (2) between modules (1), which helps their adaptation to the ground (regardless of the irregularities) when they align out on the ground.

Each of these modules (1) has a lower, fixed and bigger part (3) with lateral projections (4) or legs for proper stability on the ground, and an upper, mobile part (5), as a cylindrical cap, linked to the fixed part (3) with at least two telescopic cylinders (6) which, conveniently motored, are capable of lifting the mobile part (5) at a height that is suitable for the maximum value provided for the barrier made up by the device.

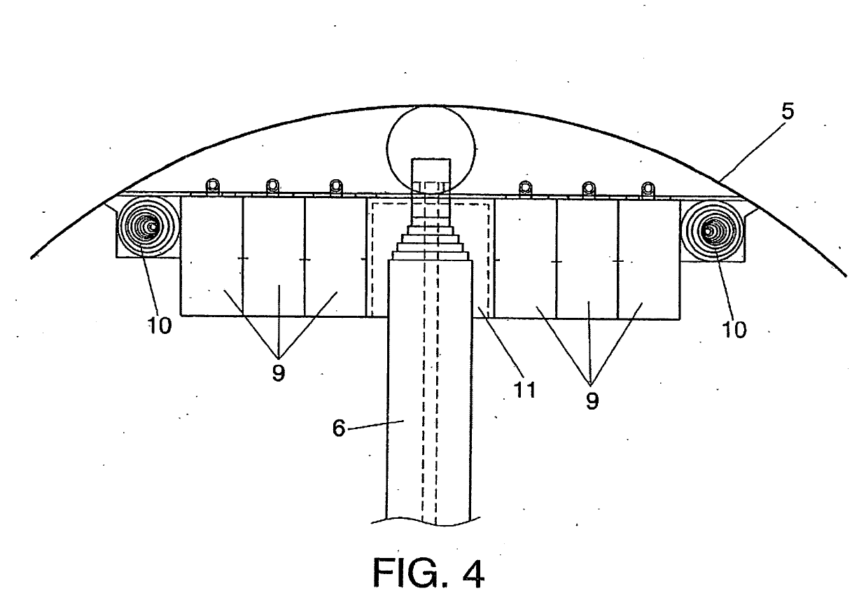

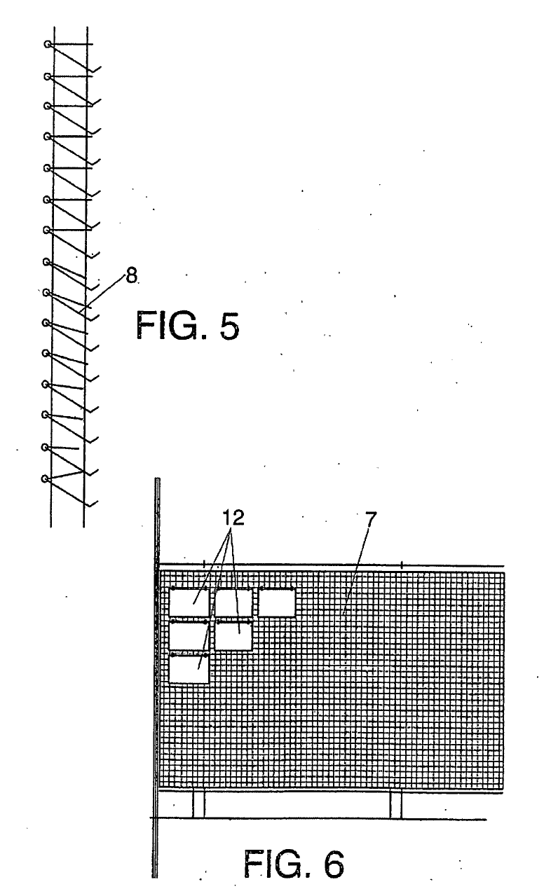

Between the fixed part (3) and the mobile part (4) are a number of meshes (7) and blinds (8), which are either rolled back or kept in storage spaces (9) set up for operating reasons in those fixed and mobile pieces or parts, and which are elements that will truly constitute the fire-fighting barrier, having these meshes (7) and blinds (8) supplemented with sheets (10), which can be either rolled back in storage spaces in the mobile element (5), as it has been represented in FIG. 4, or in storage spaces of the body or fixed part (3), as it has been represented in FIG. 3, and which in any case are bound to roll out to both sides of the barrier, thus covering broad surfaces, for example, strips of about 4 metres, in which this cover (10) determines the impossibility of having the grass or weed that might be under them catching fire, thus getting the fire away from the barrier as defined by grilles and blinds (7-8).

The lower side of the fixed part (3) has storage space to keep the engines of the cylinders (6), the corresponding battery, and the electric valves in case the lower part (3) of the device is used as storage for water supply, etc.

Apparently enough, in furtherance of the specific needs of each case, the number of grilles (7) and blinds (8) may be variable upon need, and so is their lay-out in the context of the device, without any effects on the essence of the invention.

All grilles (7) are associated with a number of plates (11), as shown in FIG. 6, in which only three of them have been represented for better viewing the figure and for allowing the visualisation of the grille or mesh (7), leaving the plates (11) joined to the mesh (7) through their upper edge and with movement, making up horizontal and vertical alignments; they are big enough so as not to impair the practical nature of the set.

The rolling elements count on automatic rolling means at their axes, for example, torque-operating strings.

As structured, the device has minimum volume when it is not in operation, which makes it easy to be transported in an appropriate vehicle as well as easy to lay out on the ground.

1. A fire-breaking device, which designed as a fire fighting barrier to be mounted on the ground once the fire has broken out and near it, is characterised by comprising a number of modules (1), (1′), . . . that couple to one another coaxially, each of which is shaped as a considerable long cylinder made up of two parts: a fixed, lower one (3) and an upper, mobile one (5), which are linked to one another through telescopic cylinders (6) that allow for lifting the mobile part (5) up to the height expected for the fire fighting barrier, with a number of meshes (7) and blinds (8) constituting the firebreak proper between those fixed and mobile elements or parts; each mesh has numerous small plates (11) attached, forming horizontal and vertical alignments and joining to the mesh (7) by their upper edge.

2. The fire-breaking device according to claim 1, wherein the extremes of the abovementioned modules (1), (1′), . . . have concave and convex surfaces that allow for knee-cap-like coupling (2) between modules, thus keeping perfect continuity, and have also ways of mutual coupling.

3. The fire-breaking device according to claim 1, wherein the fixed part (3), capable of serving as storage for water supply, has wings or protuberance (4) in its lower side for adequate stabilisation to the ground so that the mobile part (5) looks up.

4. The fire-breaking device according to claim 1, wherein the mobile part (5) is provided with storage spaces (9) and means to roll back the mesh and blinds, which on the other extreme operate in the same way on the fixed part (3), rolling out when the mobile part is lifted (5) and rolling in when that mobile part goes down.

5. The fire-breaking device according to claim 1, wherein the lower side (3) is provided with an empty space for locating the engines of the telescopic cylinders (6), of the water pumps and other mechanisms for device operation as well as the battery for electric power supply of these elements.

6. The fire-breaking device according to claim 1, wherein preferably next to the crown of the lower, fixed part (3) there should be means for rolling two sheets (10), capable to roll out on both sides of the module (1, 1′, . . . ) covering broad surfaces of about 4 metres, covering the ground vegetation and protecting it from being affected by the flames, with the provision of having these sheets (10) as well as the meshes (7) and blinds (8), and the rest of the structure of the device made of materials that can endure the high temperatures reached by the fire.
